(19) United States
(12) Patent Application Publication
(10) Pub. No.: US 2024/0249129 A1
(43) Pub. Date: Jul. 25, 2024

(54) RANGE BASED HARDWARE OPTIMIZATION OF NEURAL NETWORK SYSTEM AND RELATED METHOD

(71) Applicant: UNIVERSITY OF SOUTH FLORIDA, Tampa, FL (US)

(72) Inventor: Srinivas Katkoori, Wesley Chapel, FL (US)

(21) Appl. No.: 18/391,455

(22) Filed: Dec. 20, 2023

Related U.S. Application Data
(60) Provisional application No. 63/480,827, filed on Jan. 20, 2023.

(51) Int. Cl. G06N 3/063

(52) U.S. Cl. CPC G06N 3/063

(57) ABSTRACT

Methods and systems for range-based hardware optimization of a neural network model are disclosed. The methods and systems include: obtaining a trained neural network model, the trained neural network model comprising: a plurality of neurons; determining a plurality of ranges for the plurality of neurons based on a plurality of training datasets, the plurality of ranges corresponding to the plurality of neurons; removing a first neuron from the trained neural network model based on a first range of the plurality of ranges to decrease hardware computational resources utilized for the first neuron; and generating an optimized neural network model based on the plurality of neurons without the first neuron. Other aspects, embodiments, and features are also claimed and described.

### CROSS-REFERENCE TO RELATED APPLICATION(S)

This application is based on, claims priority to, and incorporates herein by reference in their entirety U.S. Provisional Application Ser. No. 63/480,827, filed Jan. 20, 2023.

### STATEMENT REGARDING FEDERALLY SPONSORED RESEARCH

N/A

### BACKGROUND

The Internet of things has expanded to include applications in every industry imaginable. Millions of individuals use wearables, smartphones, or tablets to access applications like image classification or speech recognition. The devices and sensors are also used for related fields such as computer vision or automation and edge technology. Contrary to high-performance computing, which is more typically linked to deep learning models, these new fields have constrained power requirements and constrained processing capacity.

Although deep neural networks (DNNs), in particular convolutional neural networks and recurrent neural networks, represent the state-of-the-art in many applications, their growing complexity necessitates the use of powerful hardware. In recent years, the complexity of neurons and layers in DNNs has grown exponentially to attain state-of-the-art or even surpass the classification rates in fields such as object recognition. In addition to a much higher demand for computational capabilities, such networks now require larger storage spaces. This is particularly difficult for embedded systems, as memory is often a limited resource. In particular, access to off-chip memories accounts for most of the energy usage. In fact, the inference and training processes for these models require tens of millions of multiply and accumulate (MAC) operations, which are extremely computationally intensive. For each MAC operation, at least two memory accesses are needed. There is a need to impose a constraint on the memory bandwidth in order to implement these compute-intensive algorithms with low latency. As the demand for neural network usage and smart devices with limited resources continues to increase, research and development continue to advance neural network technologies to meet the growing demand for smart devices with limited resources.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for range-based hardware optimization are disclosed. These methods, systems, and apparatus for range-based hardware optimization may include steps or components for: obtaining a trained neural network model, the trained neural network model comprising a plurality of neurons: determining a plurality of ranges for the plurality of neurons based on a plurality of training datasets, the plurality of ranges corresponding to the plurality of neurons; removing a first neuron from the trained neural network model based on a first range of the plurality of ranges to decrease hardware computational resources utilized for the first neuron: and generating an optimized circuit layout for hardware that implements an optimized neural network model generated based on the plurality of neurons without the first neuron.

In further aspects of the present disclosure, an apparatus for range-based hardware optimization are disclosed. The apparatus for range-based hardware optimization may include an electronic processor having a set of input pins and a set of output pins, and a layout of circuit gates implementing an optimized neural network model, the optimized neural network model obtained by removing a first neuron of a plurality of neurons in a trained neural network model to decrease hardware computational resources utilized for the first neuron. The layout causes the electronic processor to: when receiving a runtime dataset for a patient via the set of input pins, extract a plurality of features from the runtime dataset: apply the plurality of features to the optimized neural network model to obtain a confidence level: and output a prediction indication based on the confidence level via the output pins.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flowchart illustrating an example range-based hardware optimization of a neural network model.

FIG. 2 is a block diagram conceptually illustrating a system for range-based hardware optimization of neural networks according to some embodiments.

FIG. 3 is a flow diagram illustrating a process for an example range-based hardware optimization neural network according to some embodiments.

FIG. 4 illustrates an example of multilayer perceptron.

FIG. 5 illustrates an example graphic representation of a rectified linear unit (ReLU).

FIG. 6A illustrates an example representation of a regular multilayer perceptron network, and FIG. 6B illustrates an example representation of an example range-based hardware optimization neural network according to some embodiments.

FIG. 7 is a flow diagram illustrating a process using an example range-based hardware optimization neural network according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

As described above, the state-of-the-art neural networks may not be suitable for embedded systems, sensors, wearables, smartphones, or tablets, which have constrained power requirements and constrained processing capacity. Thus, there is a need to implement the compute-intensive algorithms, which are neural networks, with low latency and less memory space.

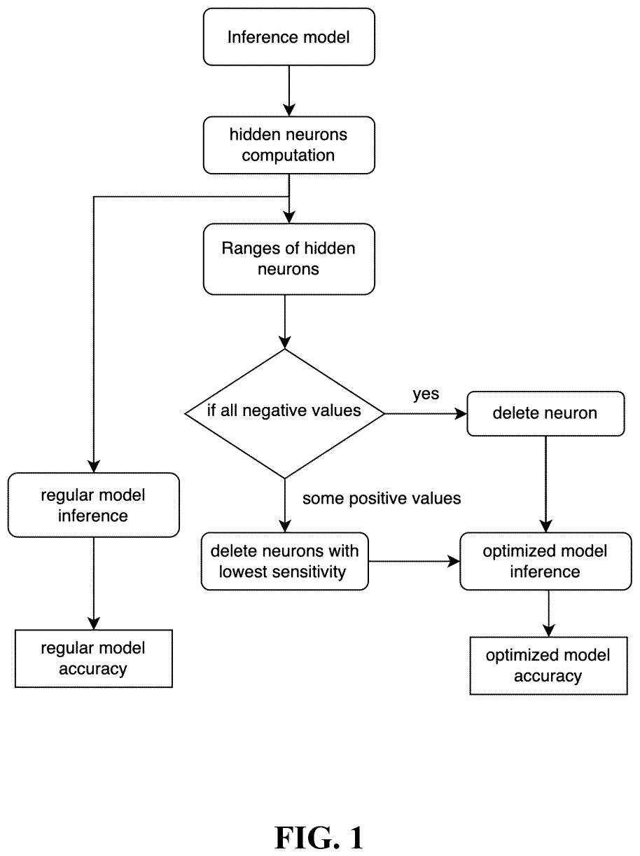

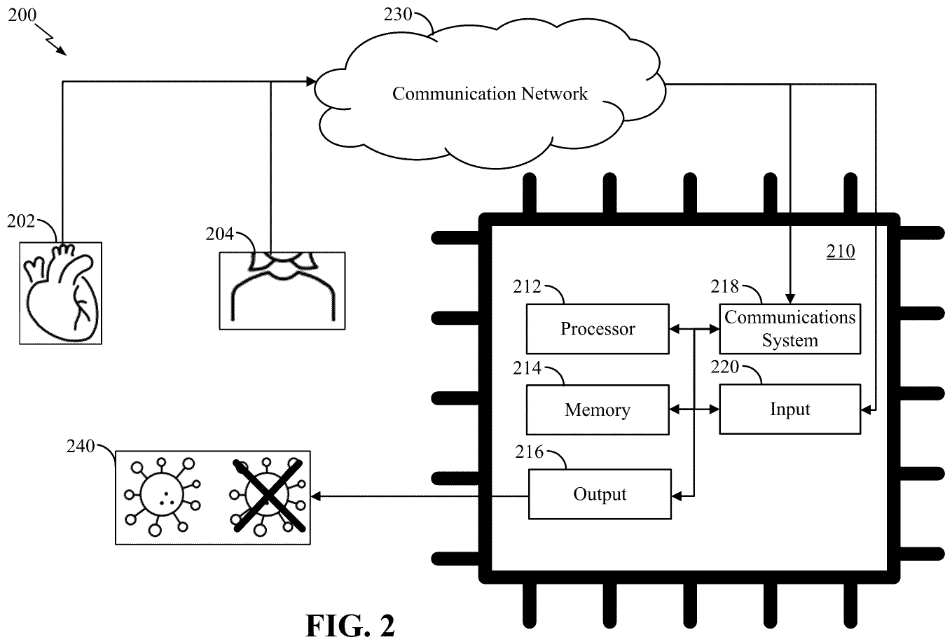

Accordingly, some embodiments disclosed herein can optimize hardware for the neural networks. For example, FIG. 1 shows a flowchart of an example range-based hardware optimization of a neural network model. For example, the hardware optimization can be performed on a pre-trained neural network model. The neural network model can be trained on the cloud and the trained neural network model can be obtained and stored in a memory (e.g., memory 214 in FIG. 2). In some examples, multiple training datasets can be applied to the trained neural network model to profile hidden layer nueraons of the neural network model. Then, ranges of each neuron in the trained neural network model can be determined. If all of values in the range of a hidden neuron are negative, the neuron including a multiplexer and multiple adders can be deleted. If the hidden neuron has some positive values, the sensitivity of the neuron can be calculated. The sensitivity can be calculated by accounting for the hidden neuron values after the rectified linear unit (ReLU) activition. Based on the neural network model without the deleted neurons, an optimized neural network model can be generated. Then, inference can be run on a runtime dataset. Thus, the optimized neural network model can perform classification problems with minimal loss in accuracy. Further, the optimized neural network model disclosed herein can have a reduction in the resource consumption of a trained neural network model by reducing hardware resources (i.e., reducing the number of adders and multipliers) utilized for the neural network model. Therefore, some embodiments disclosed herein can decrease hardware computational resources utilized for neural networks with low latency and minimal loss in accuracy.

### Example Range-Based Hardware Optimization System

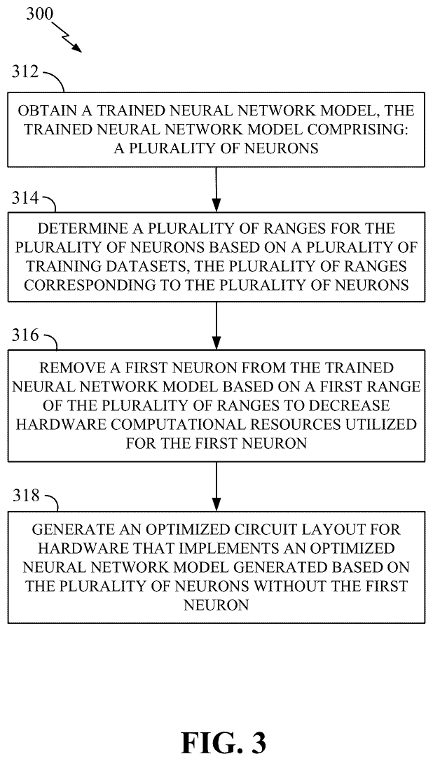

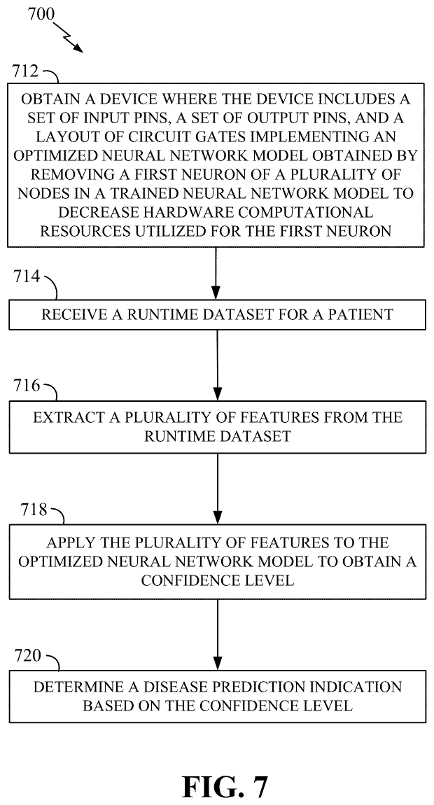

FIG. 2 shows a block diagram illustrating a system 200 for range-based hardware optimization for a neural network model according to some embodiments. The computing device 210 can be an integrated circuit (IC), a computing chip, or any suitable computing device. In some examples, the computing device 210 can be a special purpose device to implement a neural network model. Thus, the process 300 or 700 described in FIG. 3 or 7 is tied to a special purpose device.

In the system 200, a computing device 210 can obtain or receive a dataset. The dataset can be a heart disease dataset 202, a breast cancer dataset 204, an Iris flower dataset, or any other suitable dataset to classify the dataset into one of multiple classes. For example, the dataset can include an image, a medical record, X-ray data, magnetic resonance imaging (MRI) data, computed tomography (CT) data, or any other suitable data for classification. In other examples, the dataset can include one or more features extracted from input data. Also, in some examples, the dataset can include a training dataset to be used to optimize hardware for a neural network model. In other examples, the dataset can include a runtime dataset for a patient. In some examples, the dataset can be produced by one or more sensors or devices (e.g., X-ray imaging machine, CT machine, MRI machine, a cell phone, or any other suitable devices). In some examples, the dataset can be directly applied to the neural network model. In other examples, one or more features can be extracted from the dataset and be applied to the neural network model. The computing device 210 can receive the dataset, which is stored in a database, via communication network 230 and a communications system 218 or an input 220 of the computing device 210.

The computing device 210 can include an electronic processor 212, a set of input pins (i.e., input 220), a set of output pins, and a layout of circuit gates or circuit gates, which cause the electronic processor 212 to perform instructions, which are stored in a memory 214.

The computing device 210 can include a processor 212. In some embodiments, the processor 212 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

The computing device 210 can further include a memory 214. The memory 214 can include any suitable storage device or devices that can be used to store suitable data (e.g., the dataset, a trained neural network model, an optimized neural network model, etc.) and instructions that can be used, for example, by the processor 212 to: when receiving a runtime dataset for a patient via the set of input pins, extract a plurality of features from the runtime dataset: apply the plurality of features to the optimized neural network model to obtain a confidence level: output a prediction indication based on the confidence level via the output pins: obtain a trained neural network model, the trained neural network model comprising a plurality of neurons: determine a plurality of ranges for the plurality of neurons based on a plurality of training datasets, the plurality of ranges corresponding to the plurality of neurons: remove a first neuron from the trained neural network model based on a first range of the plurality of ranges to decrease hardware computational resources utilized for the first neuron: generate an optimized circuit layout for hardware that implements an optimized neural network model generated based on the plurality of neurons without the first neuron: manufacture a chip according to the optimized circuit layout, wherein the chip has a first number of gates less than a second number of gates for a second chip implementing the trained neural network model: and remove the rectified linear unit associated with the first neuron. The memory 214 can include a non-transitory computer-readable medium including any suitable volatile memory, non-volatile memory, storage, or any suitable combination thereof. For example, memory 214 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 212 can execute at least a portion of process 200 or 700 described below in connection with FIG. 3 or 7.

The computing device 210 can further include a communications system 218. The communications system 218 can include any suitable hardware, firmware, and/or software for communicating information over the communication network 240 and/or any other suitable communication networks. For example, the communications system 218 can include one or more transceivers, one or more communication chips and/or chip sets, etc. In a more particular example, the communications system 218 can include hardware, firmware and/or software that can be used to establish a Wi-Fi connection, a Bluetooth connection, a cellular connection, an Ethernet connection, etc.

The computing device 210 can receive or transmit information (e.g., dataset 202, 204, a disease prediction indication 240, a trained neural network, etc.) and/or any other suitable system over a communication network 230. In some examples, the communication network 230 can be any suitable communication network or combination of communication networks. For example, the communication network 230 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 230 can be a local area network, a wide area network, a public network (e.g., the Internet), a private or semi-private network (e.g., a corporate or university intranet), any other suitable type of network, or any suitable combination of networks. Communications links shown in FIG. 2 can each be any suitable communications link or combination of communications links, such as wired links, fiber optic links, Wi-Fi links, Bluetooth links, cellular links, etc.

In some examples, the computing device 210 can further include an output 216. The output 216 can include a set of output pins to output a prediction indication. In other examples, the output 216 can include a display to output a prediction indication. In some embodiments, the display 216 can include any suitable display devices, such as a computer monitor, a touchscreen, a television, an infotainment screen, etc. to display the report, the human activity indication 240, or any suitable result of a disease prediction indication 240). In further examples, the disease prediction indication 240 or any other suitable indication can be transmitted to another system or device over the communication network 230. In further examples, the computing device 210 can include an input 220. The input can include a set of input pins to receive the dataset 202, 204. In other examples, the input 220 can include any suitable input devices (e.g., a keyboard, a mouse, a touchscreen, a microphone, etc.) and/or the one or more sensors that can produce the raw sensor data or the dataset 202, 204.

### Example Range-Based Hardware Optimization Process for Neural Network Model

FIG. 3 is a flow diagram illustrating an example process 300 for range-based hardware optimization for a neural network model in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., the computing device 210), the processor 212 with the memory 214, etc.) can be used to perform the example process 300. However, it should be appreciated that any suitable apparatus or means for carrying out the operations or features described below may perform the process 300.

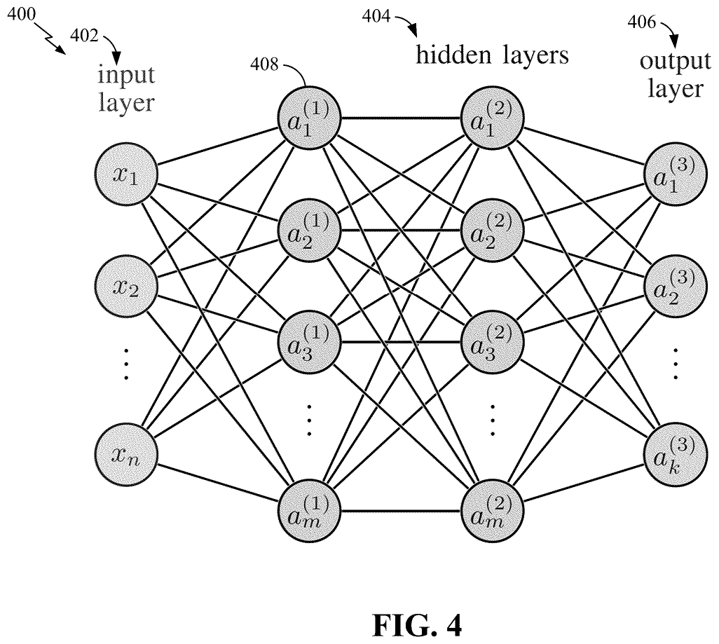

At step 312, the process 300 can obtain a trained neural network model. For example, the trained neural network model can include a feed forward neural network model (e.g., a single-layer feedforward neural network model, a multilayer feedforward neural network model, etc.). In some examples, the trained neural network model can include a multilayer perceptron neural network model. FIG. 4 shows an multilayer perceptron (MLP) neural network model 400 of Feed Forward Neural Network (FFNN). The MLP neural network model 400 is a fully connected network, with n input neurons, m hidden neurons in both hidden layers, and k output neurons. The MLP neural network model 400 is a type of feed-forward neural network, which works as approximators. The multilayer perceptron neural network model 400 can apply a non-linear mapping of the input vectors to respective output vectors. The multilayer perceptron neural network model 400 can include the following layers, arranged as a combination of several neurons in each layer: an input layer 402, one or more hidden layers 404, and an output layer 406. The input layer 402 is where data for processing is acquired. The input features (e.g., x₁, x₂ . . . . xₙ) are distributed to feed into the hidden layer 404. The computational engine of the MLP neural network model is formed of an arbitrary number of hidden layers 404 positioned between the input and output layers 402, 404. Increasing the total number of hidden layers in an MLP network results in an increase in the overall complexity of the network. The output layer 406 performs crucial functions, such as classification and prediction. The output layer 406 computes values used for backpropagation, which is in the case of training. In the case of testing or runtime, the values can indicate confidence levels used to make a decision, which determines the class of the output (e.g., a disease prediction indication).

The flow of data, which is analogous to that of a feed-forward network, occurs from the input layer 402 to the output layer 406. The MLP neural network model 400 can include multiple neurons 408 called perceptrons, which take in n features as input vectors, each of which has a weight associated with the respective neuron. The neurons take inputs from the input layer 402 and compute the weighted sum, which is calculated using the following equation: H=Σᵢ₌₁ⁿ iᵢ*wᵢ+b, where H is a neuron, n is a number of input neurons, wᵢ is a weight for an input neuron i, and b is a bias for the neuron H. Thus, a neuron 408 can include a multiplier and a first adder for the weighted sum and a second adder for adding the bias. Thus, the multiplier can produce multiple multiplier outputs based on multiple inputs and multiple corresponding weights by multiplying multiple inputs and multiple corresponding weights, respectively (i.e., multiplier outputᵢ=iᵢ*wᵢ). The first adder can produce a first adder output based on the multiple multiplier outputs by adding the multiple multiplier outputs (i.e., first adder output=Σᵢ₌₁ⁿ multiplier outputᵢ). The second adder can produce a second adder output based on the first adder output and a bias by adding the first adder output and and bias (i.e., second adder output=first adder output+b).

The MLP neural network model 400 functions well for classification, approximation, recognition, and prediction applications where inputs have a class or label assigned to them. The MLP neural network model 400 performs well for issues involving regression prediction in which a real-valued quantity is predicted from a set of inputs. The MLP neural network model 400 is exceedingly adaptable and can generally be utilized to learn an input-to-output mapping. The MLP neural network model 400 is capable of working with diverse data types because of its versatility. The parameters in the MLP neural network model 400 are now provided to the activation function. The MLP neural network model 400 can utilize the rectified linear unit (ReLU), which is an activation function. Each of the neurons in the network is connected to all the neurons in the previous layer, and the next layer giving the name fully connected layers. The parameters of each neuron can be discreet. Each input data point can have a ground truth or label associated, and the label of the input data point can belong to a class or class label. At the output layer 406, the class score or a confidence level is used to determine the class of the output.

In some examples, a loss function can be defined and be used to evaluate the performance of the classifier. Some loss functions for classifiers are exponential, logistic, square, and so on. Using one of them, the output loss is calculated and optimized for minimal output loss. These are adaptive learning algorithms that learn per parameter, allowing for more heuristic learning. For example, the Adam optimizer can be used. In some cases, first weights and biases are randomly initiated and over multiple iterations, and the weights and biases are refined to get a lower loss. After calculating the loss, backpropagation is utilized to reduce loss and update the weights of the model by using the gradient. The weights are adjusted in the direction of the gradient flow. The adjustment is used in training as this determines the parameters that yield the optimal loss.

The activation function in the MLP neural network model 400 can convert the output of the previous layer into the input of the next layer. The output of each neuron is calculated by multiplying the weight and the input and adding them together. The bias is added to the sum and passed through the activation function. The activation function determines if the neuron is activated or not. The weight and bias of each neuron activation determine how those neurons behave in neural networks. In a neural network, the parameters of the network (weights and biases) are updated based on the error at the output using backpropagation.

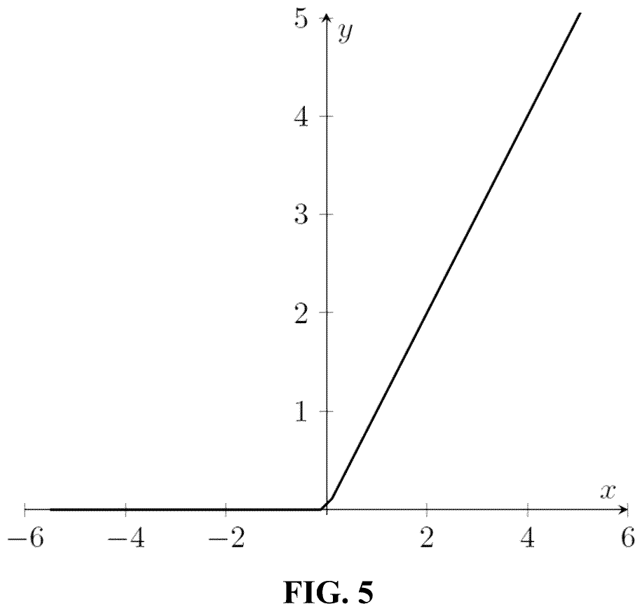

If the input is positive, the piecewise linear function known as the rectified linear unit (ReLU) can produce the output directly while producing zero if the input is negative. It has evolved into the go-to approach for activating a wide range of different networks. It is easy to train a network with simple linear activation functions; however, such a network is hard to learn complex mapping functions. It can be determined using the following equation: ReLU(x)=max(0,x). FIG. 5 graphically depicts the ReLU's output.

Softmax is commonly utilized in the final layer, or the output layer of a neural network, as the activation function to convert outputs into probabilities. Each output value of the softmax function indicates the probability that a particular class will contain the associated value. The raw outputs of the neural network are turned into a vector of probabilities by the softmax activation function. This is basically a probability distribution over the input classes. Predicting a class label and estimating the probability of a class label for a given input is the aim of classification problems. The network has been carefully configured to produce N values, one for each category represented by the classification model. After that, the outputs are normalized by implementing the softmax function, which changes them from weighted sum values to probabilities that add up to one. This gives the outputs that can be calculated using the following equation:

$$σ ( {z}_{i} ) = \frac{{e}^{{Z}_{i}}}{{\sum }_{j = 1}^{K} {e}^{{Z}_{j}}} for i = 1 , 2 , … , K .$$

In other examples, the trained neural network model 400 can include other types of neural network model (e.g., a recurrent neural network model, a convolutional neural network (CNN) model, a long short-term memory (LSTM) network model, etc.).

At step 314, the process 300 can determine multiple ranges for the multiple neurons based on multiple training datasets. In some examples, the multiple neurons are neurons in one or more hidden layers. Thus, in such examples, the process 300 does not need to determine ranges for neurons in an input layer or a softmax layer. The multiple ranges can correspond to the multiple neurons of the trained neural network model. Each range can include multiple neuron outputs corresponding to the multiple training datasets. For example, a training dataset can be applied to the trained neural network, and each neuron in one or more hidden layers can produce a neuron output based on the trained dataset. Thus, each neuron can produce multiple neuron outputs for the multiple training datasets where the multiple neuron outputs are included in the range of the respective neuron. The multiple neuron outputs for the respective neuron can correspond to an input to a rectified linear unit for the respective neuron, which described in connection with step 312 in FIG. 3. Thus, each neuron in the one or more hidden layers can be communicatively coupled to a rectified linear unit where the output of the rectified linear unit can be communicatively coupled to a subsequent neuron. In some examples, a neuron in a hidden layer can include a multiplexer, a first adder, and a second adder, and the neuron output of the neuron can correspond to an output of the second adder. The output of the second adder of the neuron can be used for a range of the neuron and can be linked to a rectified linear unit.

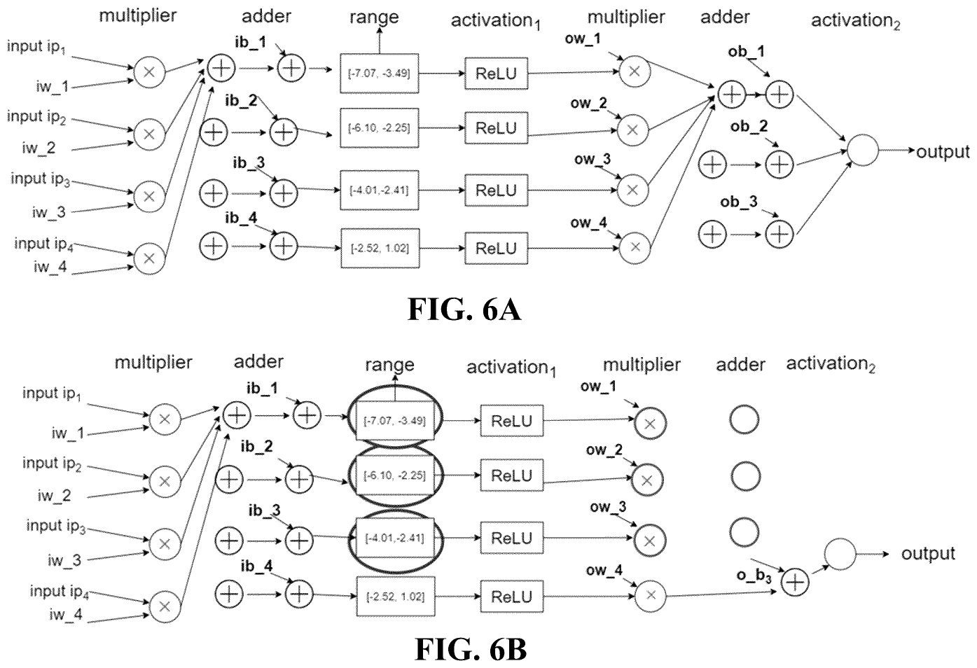

FIG. 6A shows the trained neural network model. FIG. 6A shows the number of multipliers and adders used to compute one hidden layer neuron and one output neuron. The neural network model takes in inputs input1, input2, input3, and input4 and multiplies with the first set of weights iw1, iw2, iw3, and iw4. The products and bias ip_bias1 is summed up by the adder block, which contains four adders and is passed on to the activation function block. Here the range of the hidden neurons is calculated, and the ReLU is applied. This results in h1, the first hidden neuron. Similarly, the inputs input1, input2, input3, and input4 are multiplied by a second set of weights iw5, iwe6, iw7, iw8, and they are summed. The sum is then added to ip bias2 to get h2. Similarly h3 and h4 are computed. To calculate the output neurons, h1 is multiplied with ow1, h2 is multiplied with ow2, h3 is multiplied with ow3, h4 is multiplied with ow4, their products are added to op bias1 in the adder block to compute first output neuron. Similarly, the second and third sets of output weights are used to compute the second and third output neurons, respectively. The output neurons are sent to the second activation function, the softmax function, and yield the output of the network.

At step 316, the process 300 can remove a first neuron from the trained neural network model based on a first range of the multiple ranges to decrease hardware computational resources utilized for the first neuron. For example, the first neuron can include a multiplier, a first adder, and a second adder. The multiplier is configured to produce a multiple multiplier outputs by multiplying multiple inputs and multiple corresponding weights. In some examples, the multiplier can include multiple multipliers corresponding to multiple inputs to the neuron. The first adder is configured to produce a first adder output by adding the multiple multiplier outputs, and the second adder is configured to produce a second adder output by adding the first adder output and a bias. When multiple training datasets are applied to the trained neural network model, multiple second adder outputs corresponding to the multiple training datasets can be obtained. In some examples, the multiple second adder outputs can be the multiple neuron outputs. The multiple neuron outputs for the first neuron can be included in the first range. In some examples, the process 300 can remove the first neuron from the trained neural network model when each of the multiple neuron outputs for the first neuron is a negative value. In other examples, the process 300 can remove the first neuron from the trained neural network model when each of the multiple neuron outputs for the first neuron is lower than a predetermined threshold. In further examples, the process 300 can remove the first neuron from the trained neural network model when a neuron output or an average of the multiple neuron outputs is the lowest value among other neurons in the same hidden layer or hidden layers.

In some examples, the second adder output or the neuron output for the first neuron can correspond to an input to a rectified linear unit or can be provided to the rectified linear unit for the neuron. When the process 300 removes the first neuron, the process 300 can remove the rectified linear unit associated with the first neuron. The process 300 can reduce hardware resources for the multiplexer, the first adder, the second adder, and/or the rectified linear unit for the first neuron. For example, the trained neural network model can include a first hidden layer of the multiple neurons and a second layer, which includes multiple second neurons. In some examples, to remove the first neuron, the process 300 can remove multiple input mappings in the trained neural network model from the multiple inputs to the first neuron and remove multiple output mappings in the trained neural network model from the first neuron to the multiple second neurons. Thus, in such examples, removing the first neuron can indicate removing mappings from and to the first neuron to avoid calculation for the first neuron. In other examples, the process 300 can remove circuits for the multiplier, the first adder, the second adder, and/or the rectified linear unit for the first neuron.

FIG. 6B shows the implementation of the range-optimized neural network model, where the earlier calculated range in FIG. 6A is used to profile the neurons. The first three neurons have negative ranges, so these hidden neurons are pruned or can be removed. The corresponding weights for the output layer are pruned as well. This eliminates the first three multiplier blocks and the subsequent adder blocks calculate the hidden and output neurons. In such examples, only one hidden neuron and one output neuron are calculated. From the example of FIG. 6A, four multipliers and four adders are utilized to calculate the hidden neurons and three multipliers and three adders are utilized to calculate the output neurons. However, as shown in the example of FIG. 6B, only seven multipliers and seven adders are utilized for the optimized model to compute one output. Accordingly, savings of 75% for both multiplier and adder units are achieved.

In some examples, the process 300 can remove all neurons having negative values of the ranges at the same time. In further examples, when the neural network model includes multiple hidden layers, the process 300 can remove all neurons in a first hidden layer where the range of each neuron to be removed has negative values. In such examples, the process 300 can redetermine ranges of neurons in the subsequent hidden layer to the first hidden layer because the removed neurons can affect the ranges of the neurons in the subsequent hidden layer. Then, the process 300 can remove some neurons in the subsequent hidden layer where the ranges of the neurons to be removed has the ranges of negative values in the redetermination step. If there are other hidden layers, the process 300 can repeat the process to determine ranges of a hidden layer, remove some neurons in the layer, and redetermine ranges for a subsequent hidden layer to remove neurons in the subsequent hidden layer.

At step 318, the process 300 can generate an optimized circuit layout for hardware that implements an optimized neural network model generated based on the multiple neurons without the first neuron. For example, the optimized neural network model can be the trained neural network model except for the first neuron. Accordingly, the optimized circuit layout can include less circuit gates (e.g., multiplexer, adder, ReLU, etc.) to implement the optimized neural network model than circuit gates to implements the trained neural network model, which has not been optimized without removing the first neuron. In some examples, the process 300 can also manufacture a chip according to the optimized circuit layout where the chip has a first number of gates less than a second number of gates for a second chip implementing the trained neural network model. Accordingly, the chip or device implementing the optimized neural network model can save the hardware resources for the first neuron, and the process 300 can use the saved hardware resources for other neurons, which lead to low latency or process the other neurons with minimal delay.

### Example Process Using Optimized Neural Network Model

FIG. 7 is a flow diagram illustrating an example process 300 using the optimized neural network model in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., the computing device 210, the processor 212 with the memory 214, etc.) can be used to perform the example process 700. In other examples, a preliminary step 712 to obtain a device can be performed by a user or a system while other steps 714, 716, 718 can be performed by the device. The device can include the computing device 210, the processor 212 with the memory 214, the input 220, and/or the output 216. However, it should be appreciated that any suitable apparatus or means for carrying out the operations or features described below may perform the process 300.

At step 712, the process 712 can obtain a device where the device includes a set of input pins, a set of output pins, and a layout of circuit gates implementing an optimized neural network model obtained by removing a first neuron of multiple neurons in a trained neural network model to decrease hardware computational resources utilized for the first neuron. In some examples, the optimized neural network model is described in connection with the process 300 in FIG. 3. For example, the circuit gates for the first neuron can include a multiplier, a first adder, and a second adder. The first neuron of the multiple in the trained neural network model has been removed based on a first range of the first neuron where the first range includes multiple neuron outputs corresponding to multiple training datasets. Each neuron output in the first range can correspond to a second adder output of the second adder, and each neuron output was a negative value.

In some examples, the optimized neural network model can be stored in a non-transitory computer-readable medium in a device where the device may have fewer circuits for a multiplexer, one or more adders, and/or a rectified linear unit of the first neuron than the circuits for the trained neural network model. When the device includes the optimized neural network model, step 712 can be omitted.

At step 714, the process 700 can receive a runtime dataset for a patient. In some examples, the runtime dataset can include a heart disease dataset, breast cancer dataset, or any other suitable dataset to classify the dataset into two or more classes.

At step 716, the process 700 can extract multiple features from the runtime dataset. For example, a feature can include a number, a character, a string of characters, one or more symbols, an image, a medical record, X-ray data, magnetic resonance imaging (MRI) data, computed tomography (CT) data, or any other suitable data for classification.

At step 718, the process 700 can apply the multiple features to the optimized neural network model to obtain a confidence level. In some examples, when the runtime dataset includes a heart disease dataset, and the confidence level can include a possibility indication of heart disease in the patient. In other examples, when the runtime dataset includes a breast cancer dataset, the confidence level can include a possibility indication of breast cancer in the patient. In some examples, the confidence level can include a numeric value, a symbol, or any suitable indication.

At step 720, the process 700 can provide a disease prediction indication based on the confidence level. For example, the disease prediction indication can include a percentage, a binary indication (sick or heathy), a symbol, one of multiple classes or gravity level of the disease, or any other suitable indication. In some examples, when the runtime dataset includes a heart disease dataset, the process 700 can determine and provide the disease prediction indication (e.g., whether the patient suffers from the heart disease) to the patient. In other examples, when the runtime dataset includes a breast cancer disease dataset, the process 700 can determine and provide the disease prediction indication (e.g., whether the patient suffers from the breast cancer) to the patient. In further examples, the disease prediction indication can be shown in the display 216 of the device 210 or transmitted to other system via the communication network 230 in FIG. 2.

### Experimental Results

This section describes the experimental setup and validates the disclosed methodology. The experimental setup includes training MLP network using the cloud to generate a model and its parameters (weights and biases). The disclose range-based optimization algorithm method ran on ten models trained independently, and the results are tabulated.

The range optimization was applied on three classification datasets. The Iris flower dataset, the heart disease dataset, and the breast cancer dataset (diagnostic) were utilized from the UCI machine learning repository, respectively. Table 1 tabulates the details of each network with input features, the number of hidden neurons, and the number of output neurons.

TABLE 1
MLP network models and their configuration.

| MLP network | # inputs | # hidden | # output |
|---|---|---|---|
| Iris flower classification | 4 | 4 | 3 |
| Heart Disease prediction | 13 | 10 | 2 |
| Breast Cancer prediction | 30 | 10 | 2 |

The hardware resource utilization of the single-precision floating point (FP32) multiplier and adder architecture was estimated. One unit of FP32 multiplier and adder for Virtex®-7vx485tffg1157-1 FPGA was synthetized with Vivado v.2019.2 tool. From the synthesis, 60 LUTs and 51 LUTs are utilized for the FP32 multiplier and adder, respectively.

Iris Flower Dataset: The Iris flower dataset is one of the predominantly used databases for classification problems. This dataset contains five attributes: sepal length, sepal width, petal length, petal width, and species. A simple MLP network was designed with four input neurons, four hidden neurons, and three output neurons. Table 2 shows the experimental results on the Iris flower classification dataset and shows the number of hidden neurons pruned after profiling for each model. No loss in accuracy was observed when hidden neurons are pruned or removed. Table 3 shows each model the number of multiplier and adder units for computation of output layer neurons. The savings were calculated for each model by pruning or removing two or three hidden neurons to compute the output layer neurons. From Table 3, an average of 57.5% of multiplier and 57.5% of adder resources was saved.

TABLE 2
Optimization results for Iris flower classification.

| | # neurons | Accuracy (%) in | Accuracy (%) in | Loss (%) |
|---|---|---|---|---|
| Exp # | removed | regular model | disclosed model | accuracy |
| 1 | 2 | 94.66 | 94.66 | 0 |
| 2 | 3 | 94.66 | 94.66 | 0 |
| 3 | 2 | 95.33 | 95.33 | 0 |
| 4 | 2 | 95.33 | 95.33 | 0 |
| 5 | 3 | 94.66 | 94.66 | 0 |
| 6 | 2 | 96.66 | 96.66 | 0 |
| 7 | 2 | 96.60 | 96.60 | 0 |
| 8 | 2 | 96.66 | 96.66 | 0 |
| 9 | 3 | 94.66 | 94.66 | 0 |
| 10 | 2 | 96.60 | 96.60 | 0 |

TABLE 3
Comparison of the number of LUTs required
in regular and range optimized MLP model

| | # of LUTs | | resources |
|---|---|---|---|
| Classification dataset | regular model | proposed model | saving |
| Iris flower | 1680 | 840 | 50% |
| Heart Disease | 9000 | 8100 | 10% |
| Breast Cancer | 19200 | 13440 | 30% |

Heart Disease Prediction Dataset: The heart disease prediction dataset dates from 1988 and includes four databases: Cleveland, Hungary, Switzerland, and Long Beach V. The target field refers to the presence or absence of heart disease, depending on the 13 original attributes.

The example MLP network model has 13 input attributes, one hidden layer of ten neurons, and one output layer with two neurons. Table 4 shows the experimental results of the heart disease prediction dataset. Table 3 shows the number of hidden neurons pruned based on sensitivity for each model. The estimated savings were calculated for each model by pruning one and two hidden neurons to compute the output layer neurons. The average loss in accuracy is 3.7%. was observed Table 3 shows the number of multiplier and adder units for the computation of output layer neurons for each model. The number of multiplier and adder units in the regular model was compared with the disclosed model. Then, the savings were estimated for each model, and the results are tabulated in Table 3. An average of 14% of multiplier and 14% adder resources was saved.

TABLE 4
Optimization results for Heart Disease prediction.

| | # neurons | Accuracy (%) in | Accuracy (%) in | Loss (%) in |
|---|---|---|---|---|
| Exp # | removed | regular model | disclosed model | accuracy |
| 1 | 2 | 99.02 | 94.24 | 4.78 |
| 2 | 2 | 100.0 | 94.82 | 5.18 |
| 3 | 1 | 98.73 | 94.53 | 4.2 |
| 4 | 1 | 100 | 97.46 | 2.54 |
| 5 | 1 | 99.31 | 94.53 | 4.77 |
| 6 | 1 | 99.70 | 98.14 | 1.56 |
| 7 | 1 | 100 | 98.43 | 1.57 |
| 8 | 2 | 99.70 | 94.63 | 5.7 |
| 9 | 2 | 98.43 | 94.14 | 4.29 |
| 10 | 1 | 98.43 | 96.0 | 2.43 |

| | |
|---|---|
| Average loss in accuracy | 3.7 |

Breast Cancer Prediction Dataset: This dataset is a part of UCI Machine Learning Repository, and was obtained from the University of Wisconsin Hospitals, Madison, by Dr. William H. Wolberg. The disclosed MLP network has ten attributes or input features of the dataset, ten hidden neurons, and two output neurons. Table 5 shows the number of hidden neurons pruned after profiling for each model. The estimated savings were calculated for each model by pruning or removing two and three hidden neurons to compute the output neurons. The average loss in accuracy is 0.57%. Table 3 shows the number of multiplier and adder units for the computation of output neurons for each model comparing number of multiplier and adder units in the regular model with the proposed model. Then, the savings were estimated for each model, and the results are tabulated in Table 3. From Table 3, an average of 24% of multiplier and 24% of adder resources was saved.

TABLE 5
Optimization results for Breast Cancer prediction.

| | # neurons | Accuracy (%) in | Accuracy (%) in | Loss (%) in |
|---|---|---|---|---|
| Exp # | removed | regular model | disclosed model | accuracy |
| 1 | 2 | 97.35 | 96.65 | 0.7 |
| 2 | 3 | 97.88 | 97.53 | 0.35 |
| 3 | 2 | 98.06 | 97.88 | 0.18 |
| 4 | 3 | 98.06 | 97.88 | 0.18 |
| 5 | 3 | 98.41 | 98.06 | 0.35 |
| 6 | 3 | 99.11 | 98.94 | 0.17 |
| 7 | 2 | 98.41 | 97.53 | 0.88 |
| 8 | 3 | 98.76 | 98.59 | 0.17 |
| 9 | 3 | 97.88 | 96.65 | 1.23 |
| 10 | 2 | 98.76 | 97.18 | 1.58 |

| | |
|---|---|
| Average loss in accuracy | 0.57 |

Table 6 shows the profile of the neurons for one experimental run on the breast cancer prediction. The data tabulated shows the sensitivity of each hidden neuron. Each column represents hidden neuron pruned, Accuracyregular, and Accuracypruned, respectively. The neurons that have the least sensitivity are pruned for optimal results. The impact of removing each neuron; some, like neuron 1, have no impact, while neuron 6 and 10 have resulted in a loss of 0.88 percent.

TABLE 6
Profile of hidden neurons for one experimental
run on Breast Cancer prediction.

| Neuron | Accuracy (%) in | Accuracy (%) in | Loss (%) in |
|---|---|---|---|
| removed | regular model | disclosed model | accuracy |
| 1 | 98.06 | 98.06 | 0 |
| 2 | 98.06 | 96.30 | 1.76 |
| 3 | 98.06 | 98.06 | 0 |
| 4 | 98.06 | 97.88 | 0.18 |
| 5 | 98.06 | 97.88 | 0.18 |
| 6 | 98.06 | 97.18 | 0.88 |
| 7 | 98.06 | 97.71 | 0.95 |
| 8 | 98.06 | 97.71 | 0.95 |
| 9 | 98.06 | 97.71 | 0.95 |
| 10 | 98.06 | 97.18 | 0.88 |

The results in Table 3 demonstrate that the range-optimized MLP model in this experimental observations significantly reduces the multiplier resource utilization of FPGA in terms of LUTs. In this, the Iris flower classification dataset was tabulated with two neurons pruned to save 50%, and one neuron for the Heart Disease dataset to save 10% resources. Three hidden neurons were pruned or removed for the breast cancer prediction dataset, resulting in 30% resource savings.

In summary, the effectiveness of the disclosed approach is demonstrated to reduce the hardware requirements for a given MLP model. For three classification datasets, average savings of 31.8% of multipliers and 31.8% adders with a 1.42% loss of model accuracy were achieved.

Accordingly, the notion of neuron sensitivity based on inference model profiling were introduced with training set in the disclosure. The MLP networks were effectively optimized. For three classification datasets, significant area savings (˜30%) are achieved with a low loss (˜1.5%) of model accuracy.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A device, comprising:
an electronic processor having:
a set of input pins;
a set of output pins; and
a layout of circuit gates implementing an optimized neural network model, the optimized neural network model obtained by removing a first neuron of a plurality of neurons in a trained neural network model to decrease hardware computational resources utilized for the first neuron; and
wherein the layout causes the electronic processor to:
when receiving a runtime dataset for a patient via the set of input pins, extract a plurality of features from the runtime dataset;
apply the plurality of features to the optimized neural network model to obtain a confidence level; and
output a prediction indication based on the confidence level via the output pins.

2. The device of claim 1, wherein the first neuron comprises a multiplier, a first adder, and a second adder,
wherein the first neuron of the plurality of neurons in the trained neural network model has been removed based on a first range of the first neuron,
wherein the first range comprises a plurality of first neuron outputs corresponding to a plurality of training datasets,
wherein each of the plurality of first neuron outputs corresponds to a second adder output of the second adder, and
wherein each of the plurality of first neuron outputs was a negative value.

3. The device of claim 1, wherein the runtime dataset comprises a heart disease dataset, and
wherein the confidence level comprises a possibility indication of heart disease in the patient.

4. The device of claim 1, wherein the runtime dataset comprises a breast cancer dataset, and
wherein the confidence level comprises a possibility indication of breast cancer in the patient.

5. A method for range-based hardware optimization, comprising:
obtaining a trained neural network model, the trained neural network model comprising a plurality of neurons;
determining a plurality of ranges for the plurality of neurons based on a plurality of training datasets, the plurality of ranges corresponding to the plurality of neurons;
removing a first neuron from the trained neural network model based on a first range of the plurality of ranges to decrease hardware computational resources utilized for the first neuron; and
generating an optimized circuit layout for hardware that implements an optimized neural network model generated based on the plurality of neurons without the first neuron.

6. The method of claim 5, further comprising:
manufacturing a chip according to the optimized circuit layout, wherein the chip has a first number of gates less than a second number of gates for a second chip implementing the trained neural network model.

7. The method of claim 5, wherein the trained neural network model comprises a multilayer perceptron neural network model.

8. The method of claim 5, wherein the first neuron comprises a multiplier, a first adder, and a second adder,
wherein the multiplier is configured to produce a plurality of multiplier outputs based on a plurality of inputs and a plurality of corresponding weights,
wherein the first adder is configured to produce a first adder output based on the plurality of multiplier outputs, and
wherein the second adder is configured to produce a second adder output based on the first adder output and a bias.

9. The method of claim 8, wherein the first range comprises a plurality of first neuron outputs corresponding to the plurality of training datasets, and
wherein each of the plurality of first neuron outputs corresponds to the second adder output.

10. The method of claim 9, wherein each of the plurality of first neuron outputs is a negative value.

11. The method of claim 8, wherein the second adder output corresponds to an input to a rectified linear unit.

12. The method of claim 11, further comprising:
removing the rectified linear unit associated with the first neuron.

13. The method of claim 8, wherein the trained neural network model comprises a first hidden layer of the plurality of neurons and a second layer,
wherein the second layer comprises a plurality of second neurons, and
wherein removing the first neuron comprises:
removing a plurality of input mappings in the trained neural network model from the plurality of inputs to the first neuron; and
removing a plurality of output mappings in the trained neural network model from the first neuron to the plurality of second neurons.

14. The method of claim 13, wherein the second layer comprises a softmax layer to convert a plurality of second neuron outputs corresponding to the plurality of second neurons into a plurality of probabilities corresponding to the plurality of second neurons.

15. A system for range-based hardware optimization, comprising:
an electronic processor, and
a non-transitory computer-readable medium storing machine-executable instructions, which, when executed by the electronic processor, cause the electronic processor to:
obtain a trained neural network model, the trained neural network model comprising: a plurality of neurons;
determine a plurality of ranges for the plurality of neurons based on a plurality of training datasets, the plurality of ranges corresponding to the plurality of neurons;
remove a first neuron based on a first range of the plurality of ranges to decrease hardware computational resources utilized for the first neuron; and
generate an optimized circuit layout for hardware that implements an optimized neural network model generated based on the plurality of neurons without the first neuron.

16. The system of claim 15, wherein the optimized circuit layout for a first chip that implements the optimized neural network model uses a first number of gates less than a second number of gates for a second circuit layout to implement the trained neural network model.

17. The system of claim 15, wherein the first neuron comprises a multiplier, a first adder, and a second adder,
wherein the multiplier is configured to produce a plurality of multiplier outputs based on a plurality of inputs and a plurality of corresponding weights,
wherein the first adder is configured to produce a first adder output based on the plurality of multiplier outputs, and
wherein the second adder is configured to produce a second adder output based on the first adder output and a bias.

18. The system of claim 17, wherein the second adder output corresponds to an input to a rectified linear unit, and
wherein the machine-executable instructions further cause the electronic processor to remove the rectified linear unit associated with the first neuron.

19. The system of claim 17, wherein the first range comprises a plurality of first neuron outputs corresponding to the plurality of training datasets, and
wherein each of the plurality of first neuron outputs corresponds to the second adder output, and
wherein each of the plurality of first neuron outputs is a negative value.

20. The system of claim 17, wherein the trained neural network model comprises a first hidden layer of the plurality of neurons and a second layer,
wherein the second layer comprises a plurality of second neurons,
wherein to remove the first neuron, the machine-executable instructions cause the electronic processor to:
remove a plurality of input mappings in the trained neural network model from a plurality of inputs to the first neuron; and
remove a plurality of output mappings in the trained neural network model from the first neuron to the plurality of second neurons, and
wherein the second layer comprises a softmax layer to convert a plurality of second neuron outputs corresponding to the plurality of second neurons into a plurality of probabilities corresponding to the plurality of second neurons.
